(19) United States
(12) Patent Application Publication
(10) Pub. No.: US 2026/0222249 A1
(43) Pub. Date: Jul. 30, 2026

(54) TRANSMITTING/RECEIVING CIRCUIT AND SIGNAL TRANSMISSION SYSTEM FORMED THEREWITH

(71) Applicant: Endress+Hauser Flowtec AG, Reinach (CH)

(72) Inventors: Werner Tanner, Lausen (CH); Pascal Buchschacher, Döttingen (CH)

(21) Appl. No.: 19/143,640

(22) PCT Filed: Dec. 12, 2023
(86) PCT No.: PCT/EP2023/087138

§ 371 Date: Jun. 26, 2025

(30) Foreign Application Priority Data
Dec. 30, 2022 (DE) 10 2022 004 950.3
Mar. 6, 2023 (DE) 10 2023 105 489.9

(51) Int. Cl. H04L 25/02

(52) U.S. Cl. CPC H04L 25/0272; H04L 25/0278

(57) ABSTRACT

The invention relates to a transmitting/receiving circuit comprising a receiver circuit (PHY-R) with a signal input (rx1, rx2) for a differential voltage signal and with a data output (Dout) for a data signal; a transmitter circuit (PHY-T) with an (electronic) current source having two electric poles (+,−), with a data input (Din) for a data signal and with a (LVDS) signal output (tx1, tx2) having connection poles (tx1, tx2) for a differential voltage signal; two (two-pole) resistance elements (R1, R2); and (for connecting a signal cable having a pair of signal conductors) a connection device with two connection poles (tr1, tr2). Each of the connection poles (tx1, tx2) is electrically connected to one of the connection poles (tr1, tr2) with one of the resistance elements connected therebetween. The transmitter circuit (PHY-T) has at least two operating modes (T-I, T-II) such that the transmitter circuit (PHY-T) is configured to convert a data signal at the data input (Din) into a differential voltage signal at the signal output in a first operating mode (T-I→transmitting operation), and to electrically short-circuit the connection poles (tx1, tx2) or keep them short-circuited in a second operating mode (T-II →terminating operation).

The invention relates to a transmitting/receiving circuit (transceiver) for, in particular ANSI/TIA/EIA-644-1995 (LVDS) compliant, (data) signal transmission and a signal transmission system formed therewith.

Differential voltage levels are also used in (industrial) measurement and/or control systems for the fast (point-to-point) transmission of digital (measurement and/or operating) data at bit rates of more than 500 kbit/s (kilobits per second); in particular, also signal transmission systems which are compliant with the ANSI/TIA/EIA-644-1995 standard (LVDS—Low Voltage Differential Signaling) are used, e.g., to serially transmit digital (payload) data, such as measurement and/or operating data, within a (stand-alone) measuring apparatus or measuring system formed by means of at least one sensor and electrically connected transducer electronics and/or from such a measuring system to an external data processing system.

Signal transmission systems of the type in question or data processing systems formed therewith are described, for example, in DE-A 102017200687, US-A 2002/0126542, US-A 2009/0203333, US-A 2015/0247747, US-A 2016/0290847, US-A 2018/0328774, US-A 2019/0107425, or the (not previously published) international patent application PCT/EP2022/084226.

As shown, inter alia, in US-A 2002/0126542, such a signal transmission system compliant with the ANSI/TIA/EIA-644-1995 standard or suitable for LVDS transmission can comprise two or more transmitting/receiving circuits (transceivers), each formed by a transmitter circuit, sometimes also referred to as an LVDS driver, a receiver circuit, two or more terminating resistors, and one or more (twisted-pair) signal cables, wherein each of the transmitter circuits has a data input for a (digital) data signal to be transmitted, a two-pole (LVDS) signal output for a differential (LVDS) voltage signal, and an electronic (direct) current source, and each of the receiver circuits has a two-pole (LVDS) signal input, having an input resistance (of typically more than 1 MΩ), for a differential (LVDS) voltage signal and a data output for a (digital) data signal.

The data signal to be transmitted, or output, by means of signal transmission systems of the type in question can, for example, be an ANSI/TIA/EIA-485 (UART—Universal Asynchronous Receiver Transmitter) compliant serial digital signal, i.e., such a binary (1-bit) data signal, with which the actual (measurement and/or operating) data is transmitted as a serial bit stream with a fixed frame (corresponding to a fixed number of transmitted bits), which typically consists of a start bit, (depending upon the protocol) five to a maximum of nine (payload) data bits, an optional parity bit for detecting transmission errors, and one or two stop bits. Data transmission can therefore be asynchronous or byte-synchronous, for example.

The transmitter circuit of each of the aforementioned transmitting/receiving circuits is designed to be electrically connected to the receiver circuit of another of the transmitting/receiving circuits by means of a pair of signal conductors (of the aforementioned signal cable), wherein the same signal conductors are also electrically together connected to a respective receiver circuit-side (respective) line end via one of the aforementioned terminating resistors—typically having more than 20 Ω(Ohm) and less than 1 k≤Ω (kilo-ohm), e.g., about 100 Ω, and wherein the signal output of the transmitter circuit and the signal input of the receiver circuit are electrically connected to one another by means of the pair of signal conductors; this in particular such that a current loop is formed involving the respective signal output, the pair of signal conductors, and a current divider formed by means of the terminating resistor (correspondingly adapted to a wave impedance of the signal cable) and the respective signal input. For connecting the signal conductors or a signal cable formed therewith, the respective transmitting/receiving circuit can have a corresponding connection device—for example, formed by means of connection pads or plug strips arranged on a printed circuit board.

The transmitter circuit of signal transmission systems of the type in question serves in particular to convert a (digital) data signal at the data input into a differential (LVDS) voltage signal at the (LVDS) signal output, in particular one that is ANSI/TIA/EIA-644-1995 (LVDS) compliant, in a transmitting mode of the respective transmitter circuit or the transmitting/receiving circuit formed therewith, which can be selected or activated, if necessary, by means of a value-discrete selection signal at a control input of the transmitter circuit. In addition, the respective receiver circuit (connected to the transmitter circuit) serves to convert the (LVDS) voltage signal supplied to the (LVDS) signal input into a (digital) data signal at the data output by establishing a transmission channel in a receiving mode (selected or activated simultaneously with the aforementioned transmitting mode) of the receiver circuit or the transmitting/receiving circuit formed therewith.

For this purpose, the transmitter circuit is configured to electrically connect or keep interconnected a positive (current source) pole (+) of the current source to one of two connection poles of the (LVDS) signal output and, complementarily thereto, a negative (current source) pole (−) of the current source to the other of the two connection poles of the (LVDS) signal output, depending upon a signal state of the data signal (at the data input), or to swap electrical connections established between the first and second (current source) poles and a different one of the two connection poles of the (LVDS) signal output, depending upon a signal edge of the data signal (mediating between two signal states). As a result, a (loop) current with a predeterminable, typically between 3 mA (milliamperes) and 10 mA, possibly also adjustable (signal) current intensity and a predeterminable current direction is driven in the aforementioned current loop by the current source of the transmitter circuit in transmitting mode, such that the (loop) current flows with alternating current direction in the current loop, wherein the (loop) current with an input signal having a first signal state (HIGH→1) has a first current direction, and that the (loop) current with an input signal having a second signal state (LOW→0) different from the first signal state has a second current direction opposite to the first current direction. The (loop) current modulated accordingly with the data signal in turn causes a (signal) voltage to drop across the terminating resistor, which serves as an input voltage of the receiver circuit and is equally modulated with the data signal, with a voltage level proportional to the (signal) current strength of the (loop) current and a polarity dependent upon the current direction of the (loop) current. Furthermore, the receiver circuit is configured to convert the (signal) voltage at the signal input into a corresponding output voltage, viz., a (signal) voltage at the signal output of the receiver circuit, in such a manner that the output voltage of the receiver circuit assumes or has a non-zero first voltage level in the case of a (positive) input voltage with a voltage level exceeding a (non-zero positive) first switching voltage threshold value or lying above the said first switching voltage threshold value.

As shown, inter alia, in US-A 20020126542, signal transmission systems of the type in question can be operated (bidirectionally) in half-duplex (HDX), such that the at least two transmitting/receiving circuits of the respective signal transmission system are allowed to operate alternately in the transmitting and receiving modes in the manner described above in order to establish first and second transmission channels with opposite transmission directions. In order to ensure that at most one of the aforementioned first and second transmission channels is activated at any one time, the transmitter circuit is typically further configured to be placed in an operating mode alternative to the transmitting mode, and in which the transmitter circuit does not process a data signal at the data input or does not deliver an (LVDS) voltage signal at the (LVDS) signal output. Alternatively or additionally, the receiver circuit is configured not to convert a differential (LVDS) voltage signal at the (LVDS) signal input into a data signal at the data output or not to output a data signal at the data output in an operating mode alternative to the receiving mode.

The (signal) quality of the (signal) voltage across the respective terminating resistor that can be achieved by means of signal transmission systems of this type with a specified transmission rate for a given (transmission) length of the signal conductor is (co-)determined not only by the electrical properties, such as in particular (wave) impedance or attenuation, of the signal conductor or the (signal) cable formed therewith, but also by the voltage of the differential (LVDS) voltage signal at the (LVDS) signal input, i.e., a (direct) current of the (loop) current and division thereof within the aforementioned current divider.

On the other hand, the electrical power available for the operation of such a signal transmission system, i.e., an electrical (transmission) power actually feedable or fed into the signal conductor by means of the respective transmitting circuit, is notoriously limited or contingent to a considerable extent; not least when used in a measuring apparatus for industrial measurement and automation technology, which regularly requires the aforementioned high transmission rates of not less than 500 kbits/s, i.e., low bit durations of not more than 2 μs (microseconds), cannot be exceeded, e.g., a (two-wire) measuring apparatus with at least temporarily low power consumption of less than 50 mW (milliwatt) or a measuring apparatus in accordance with US-A 2018/0328774; also, for example, in such a manner that the (loop) current can only be permanently set with currents of less than 10 mA, possibly also of less than 5 mA at least temporarily, or a corresponding (transmission) power of less than 10 mW, possibly also of less than 5 mW at least temporarily, is available. As a result, the (signal) transmission distance that can be bridged by means of a conventional signal transmission system of the type in question is regularly limited to a few meters, but in particular less than 20 m.

In particular, the terminating resistor of each of the transmitting/receiving circuits, which is essential for the transmission and conversion of the (LVDS) voltage signal, results in the (loop) current fed in by one of the transmitter circuits (during its transmitting operation) being divided between the aforementioned current divider and the other terminating resistor connected in parallel; this is done in such a way that, depending upon the level of an (ohmic) resistance of the signal conductor and the wave impedance (line characteristic impedance) of the signal cable formed therewith, regularly less than 70%, in particular about 50%, of the (loop) current is available for the input of the receiver circuit or can be converted into the (LVDS) voltage signal at the (LVDS) signal input.

Based upon the aforementioned prior art, one object of the invention is to improve signal transmission systems of the type in question in such a manner that digital (measurement and/or operating) data can be transmitted at a transmission rate of more than 500 kbit/s over transmission distances of more than 20 m, in particular also more than 30 m, despite an overall low available electrical power of, in particular, not more than 10 mW or a (transmission) power which can be further reduced temporarily to less than 10 mW.

To achieve this object, the invention consists in a transmitting/receiving circuit (transceiver) for, in particular ANSI/TIA/EIA-644-1995 (LVDS) compliant, (data) signal transmission, comprising:
a receiver circuit with an (LVDS) signal input, having an input resistance of more than 1 MΩ (megaohm), for an, in particular ANSI/TIA/EIA-644-1995 (LVDS) compliant, differential (LVDS) voltage signal and with a data output for an, in particular ANSI/TIA/EIA-485 (UART) compliant and/or binary, data signal;
a transmitter circuit with an, in particular controllable, electronic (direct) current source with a (positive) first electrical (current source) pole and with a (negative) second electrical (current source) pole, with a data input for an, in particular ANSI/TIA/EIA-485 (UART) compliant and/or binary, (UART) data signal and with an (LVDS) signal output having a first connection pole and a second connection pole for an, in particular ANSI/TIA/EIA-644-1995 (LVDS) compliant, differential (LVDS) voltage signal;
a first (two-pole) resistance element, in particular having an ohmic resistance of more than 10 Ω (Ohm);
a second (two-pole) resistance element, in particular having an ohmic resistance of more than 10 Ω and/or identical to the first resistance element;
and (for connecting a signal cable having a pair of signal conductors) a connecting device with a first connection pole and with a second connection pole;
wherein the first connection pole of the transmitter circuit is electrically connected, in particular permanently, to the first connection pole of the connection device with the first resistance element connected therebetween, and the second connection pole of the transmitter circuit is electrically connected, in particular permanently, to the second connection pole of the connection device with the second resistance element connected therebetween;
and wherein the transmitter circuit has at least two operating modes (T-I, T-II), in particular each of which can be selected or activated by means of at least one value-discrete selection signal at a control input of the transmitter circuit, such that
   the transmitter circuit is configured in a first operating mode (T-I→transmitting mode) to convert an, in particular ANSI/TIA/EIA-485 (UART) compliant and/or binary, (UART) data signal, in particular a 1-bit data signal, at the data input into an, in particular ANSI/TIA/EIA-644-1995 (LVDS) compliant, differential (LVDS) voltage signal at the (LVDS) signal output, viz., depending upon a signal state of the data signal (at the data input), to electrically connect or keep interconnected the first (current source) pole to one of the first and second connection poles of the (LVDS) signal output and, complementarily thereto, the second (current source) pole (−) to the other of the first and second connection poles or, depending upon a signal edge of the data signal (at the data input) (mediating between two signal states of the data signal), to swap electrical connections established between the first and second (current source) poles and a different one of the first and second terminals of the (LVDS) signal output,
   and that the transmitter circuit is configured in a second operating mode (T-II→terminating operation) to electrically short-circuit or keep short-circuited the first and second terminals of the (LVDS) signal output, in particular such that the first and second resistance elements are electrically connected in series.

Furthermore, the invention consists in a signal transmission system formed by means of such a transmitting/receiving circuit—for example, a (serial) signal transmission system for the bidirectional (point-to-point) transmission of digital (payload) data.

According to a first embodiment of the invention, it is further provided that the transmitter circuit be configured in the first operating mode to electrically connect the current source and the first and second resistance elements in series or to keep them electrically connected in series.

According to a second embodiment of the invention, it is further provided that, when the transmitter circuit is operating in the first operating mode, each of the first and second resistance elements form a series resistance of the transmitter circuit between the current source and the respective connection pole of the (LVDS) signal output—for example, limiting a (nominal) short-circuit current.

According to a third embodiment of the invention, it is further provided that the transmitter circuit be configured in the second operating mode to electrically separate or keep electrically separated the current source from at least one of the first and second connection poles of the (LVDS) signal output.

According to a fourth embodiment of the invention, it is further provided that the transmitter circuit be configured in the second operating mode to electrically separate or keep electrically separated the (LVDS) signal output from at least one of the first and second (current source) poles.

According to a fifth embodiment of the invention, it is further provided that the transmitter circuit be configured in the second operating mode to electrically connect the first and second resistance elements in series or to keep them electrically connected in series.

According to a sixth embodiment of the invention, it is further provided that the receiver circuit have at least two operating modes, each of which can be selected or activated, for example, by means of a discrete-value selection signal at a control input of the receiver circuit, such that the receiver circuit is configured, in a first operating mode (receiving mode), to convert a, for example, ANSI/TIA/EIA-644-1995 (LVDS) compliant, differential (LVDS) voltage signal at the (LVDS) signal input into a, for example, ANSI/TIA/EIA-485 (UART) compliant and/or binary, (UART) data signal, e.g., a 1-bit data signal, at the data output (Dout), and that the receiver circuit is configured, in a second operating mode, not to convert a, for example, ANSI/TIA/EIA-644-1995 (LVDS) compliant, differential (LVDS) voltage signal at the (LVDS) signal input into a data signal at the data output or not to output a data signal at the data output.

According to a seventh embodiment of the invention, it is further provided that the (LVDS) signal input of the receiver circuit have a first connection pole and a second connection pole.

According to an eighth embodiment of the invention, it is further provided that the transmitter circuit be designed as an integrated circuit—for example, as a component of an application-specific integrated circuit (ASIC).

According to a ninth embodiment of the invention, it is further provided that the receiver circuit be designed as an integrated circuit-for example, as a component of an application-specific integrated circuit (ASIC).

According to a tenth embodiment of the invention, it is further provided that the transmitter circuit and the receiver circuit be components of one and the same, e.g., application-specific, integrated circuit. According to an eleventh embodiment of the invention, it is further provided that the transmitter circuit have an (H-)bridge circuit formed by means of first, second, third, and fourth (semiconductor) switches, of which bridge circuit a supply input is electrically connected to the power source and of which bridge circuit a bridge branch is electrically connected to the first and second connection poles, e.g., such that a series circuit of the first and second switches and a series circuit of the third and fourth switches are electrically connected in parallel, and/or such that the first and fourth switches are electrically connected to the first (power source) pole, and the second and third switches are electrically connected to the second (power source) pole. In a further development of this embodiment, it is further provided that the transmitter circuit be configured, in the first operating mode, in the case of a data signal at the data input with a first signal state corresponding, for example, to logic one, both to close the (mutually diagonal) first and third switches (of the bridge circuit) or to keep them closed and to open the (mutually diagonal) second and fourth switches (of the bridge circuit) or to keep them open, and that the transmitter circuit be configured, in the first operating mode, in the case of a data signal at the data input with a second signal state, e.g., corresponding to logic zero, deviating from the first signal state, both to open the first and third switches (of the bridge circuit) or to keep them open and to close or keep the second and fourth switches (of the bridge circuit) closed. In addition, the transmitter circuit is further configured, in the first operating mode, in the case of a data signal at the data input with a signal edge transitioning from the first signal state to the second signal state, to both open and keep open the first and third switches (of the bridge circuit) and to close or keep closed the second and fourth switches (of the bridge circuit), and the transmitter circuit is configured, in the first operating mode, in the case of a data signal at the data input with a signal edge transitioning from the second signal state to the first signal state, to both close and keep closed the first and third switches (of the bridge circuit) and to open or keep open the second and fourth switches (of the bridge circuit).

According to a twelfth embodiment of the invention, it is provided that the transmitter circuit have an (H-)bridge circuit formed by means of first, second, third, and fourth (semiconductor) switches, of which bridge circuit a supply input is electrically connected to the power source and of which bridge circuit a bridge branch is electrically connected to the first and second connection poles, e.g., such that a series circuit of the first and second switches and a series circuit of the third and fourth switches are electrically connected in parallel, and/or such that the first and fourth switches are electrically connected to the first (power source) pole, and the second and third switches are electrically connected to the second (power source) pole, and it is further provided that the transmitter circuit have a (hardware) control logic with first, second, third, and fourth control outputs for controlling the first, second, third, and fourth (semiconductor) switches of the (H-)bridge circuit, respectively. In a further development of this embodiment, the control logic is further configured, in the first operating mode of the transmitter circuit, in the case of a data signal at the data input with a first signal state corresponding, for example, to logic one, both to close or keep closed the first and third switches and to open or keep open the second and fourth switches, and the control logic is further configured, in the first operating mode of the transmitter circuit, in the case of a data signal at the data input with a second signal state, e.g., corresponding to logic zero, that differs from the first signal state, both to open or keep open the first and third switches and to close or keep closed the second and fourth switches. For this purpose, each of the first, second, third, and fourth (semiconductor) switches further comprises a control terminal, each of which is electrically connected to (exactly) one associated (first, second, third, and fourth) control output of the control logic and vice versa, and/or the control logic comprises a first control input and a second control input, e.g., such that the first control input forms a control input of the transmitting/receiving circuit or is electrically coupled thereto and that the second control input forms the data input of the transmitter circuit or is electrically coupled thereto, and/or such that the first and second operating modes of the transmitter circuit can each be selected or activated by means of at least one value-discrete (binary) selection signal at the control input of the transmitter circuit.

According to a further development of the invention, the transmitting/receiving circuit further comprises: a third (two-pole) resistance element, e.g., having an ohmic resistance of more than 100 Ω, and a fourth (two-pole) resistance element—for example, having an ohmic resistance of more than 100 Ω and/or identical to the third resistance element. According to one embodiment of this further development of the invention, the (LVDS) signal input of the receiver circuit further comprises a first connection pole and a second connection pole, and it is further provided that the third resistance element electrically connect the first connection pole of the receiver circuit to the first connection pole of the connection device, and the fourth resistance element electrically connect the second connection pole of the receiver circuit to the second connection pole of the connection device, in particular permanently.

According to a further development of the signal transmission system of the invention, this further comprises: a further transmitting/receiving circuit, e.g., of the same type or construction as the transmitting/receiving circuit PHY and/or configured for signal transmission in accordance with ANSI/TIA/EIA-644-1995, and a signal cable having at least one pair of signal conductors, in particular of similar and/or identical electrical properties and/or twisted together.

According to a first embodiment of this further development of the signal transmission system, it is provided that the two transmitting/receiving circuits be electrically connected by means of the signal cable (STP) to form a current loop.

According to a second embodiment of this further development of the signal transmission system, it is provided that the signal cable have a (transmission) length of more than 20 m (meters)—for example, also more than 50 m.

According to a third embodiment of this further development of the signal transmission system, it is provided that the signal cable have a wave impedance (line characteristic impedance) of not less than 20 Ω, in particular not more than 500 Ω.

A basic idea of the invention is to cancel the current divider formed by the terminating resistor at the input of the receiver circuit in a transmitting/receiving circuit of the type in question during the transmitting operation of the associated transmitter circuit (the transmitting/receiving circuit) or to configure it only while the transmitter circuit is not operating in the transmitting mode. This makes it possible for practically the entire (loop) current fed in by the same transmitter circuit to be transferred to the other transmitter/receiver circuit or its receiver circuit, and thus a correspondingly higher proportion of the (transmission) power invested by the transmitter/receiver circuit can be converted to form the (LVDS) voltage signal received by the receiver circuit.

One advantage of the invention is that resistance elements of the transmitting/receiving circuit required for forming the terminating resistor can alternatively also serve as (fault) current limiting series resistors in the transmitting mode of the transmitter circuit. A further advantage of the invention is that both the transmitter circuit and the receiver circuit can be designed using conventional (commercially available) integrated circuits or as a component of one and the same (application-specific) integrated circuit, whereby the transmitter/receiver circuit according to the invention can also be produced at low manufacturing costs or at manufacturing costs comparable to those of conventional transmitter/receiver circuits.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially combinations of partial aspects of the invention that were initially explained only separately, furthermore emerge from the figures of the drawing and/or from the claims themselves.

### In the figures, in detail:

FIG. 1 or 2 show an exemplary embodiment of a transmitting/receiving circuit (transceiver) according to the invention;

FIG. 3 shows an exemplary embodiment of a signal transmission system according to the invention (formed by means of a transmitting/receiving circuit according to FIG. 1 or 2);

FIG. 4 or 5 show embodiments of a transmitting/receiving circuit according to FIG. 1; and

FIG. 6 shows an embodiment of a transmitting/receiving circuit according to FIG. 2.

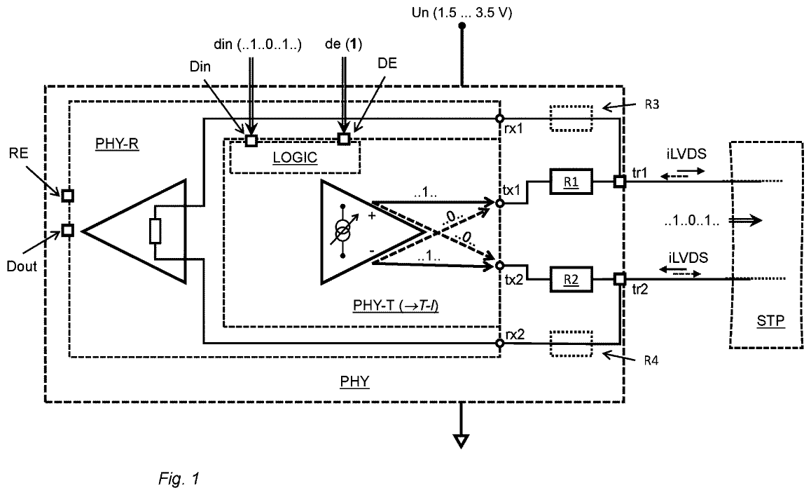

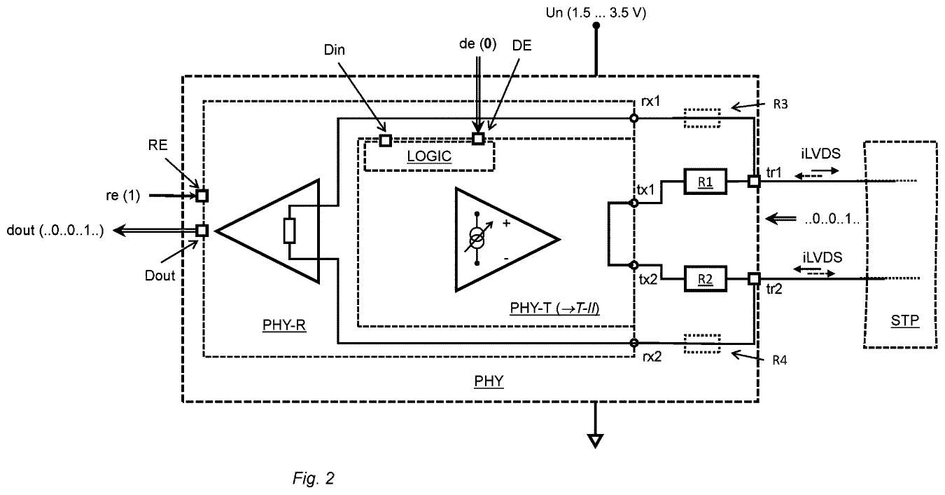

FIGS. 1 and 2 schematically show an exemplary embodiment of a transmitting/receiving circuit (transceiver) PHY according to the invention, e.g., an externally and/or battery-powered one, for (data) signal transmission, in particular for the transmission of ANSI/TIA/EIA-644-1995 (LVDS) compliant (voltage) signals.

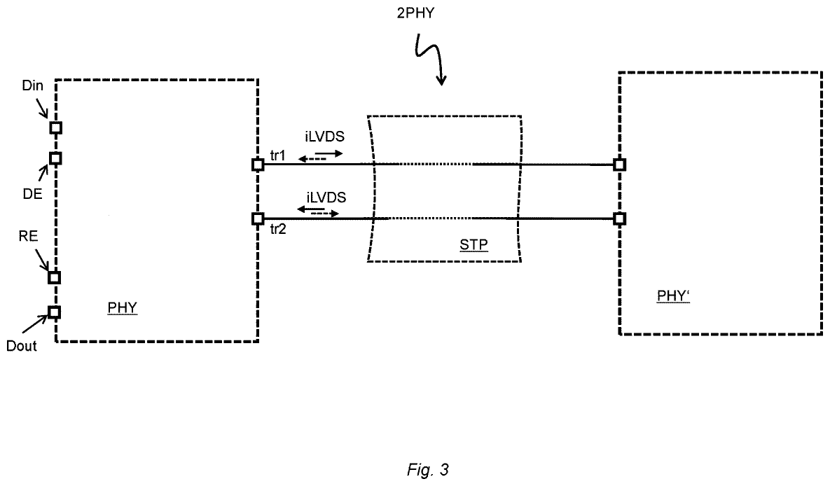

The transmitting/receiving circuit PHY according to the invention can, for example, serve as a component of a (serial) signal transmission system (2PHY) for the bidirectional (point-to-point) transmission of digital (payload) data, in particular with a bit rate of more than 500 kbit/s (kilobits per second) and/or over a distance of more than 20 m (meters), in an electronic data processing system, in particular of digital (measurement and/or operating) data in an (industrial) measurement and/or control system, and/or in an (industrial) measuring device. An exemplary embodiment of such a 2PHY signal transmission system is shown schematically in FIG. 3. The signal transmission system 2PHY comprises, in addition to the transmitting/receiving circuit PHY, another transmitting/receiving circuit PHY′, e.g., of the same type or construction as the transmitting/receiving circuit PHY and/or configured for ANSI/TIA/EIA-644-1995-compliant signal transmission, as well as a signal cable STP having at least one pair of signal conductors, in particular having similar and/or identical electrical properties and/or twisted together; this in particular such that the two transmitting/receiving circuits (PHY, PHY′) are electrically connected by means of the signal cable STP to form a current loop. The signal cable STP can advantageously be a symmetrical and/or shielded signal cable or a signal cable suitable for symmetrical signal transmission-for example, a twisted-pair cable. According to a further embodiment of the invention, the signal cable STP also has a (transmission) length of more than 20 m (meters), e.g., also more than 50 m, possibly also more than 100 m, and/or the signal cable has a wave impedance (line characteristic impedance) of not less than 20 Ω, in particular also not more than 500 Ω. Alternatively, or in addition, or also for the purpose of realizing the aforementioned wave impedance, each of the signal conductors of the signal cable STP can advantageously have a (length-)specific ohmic resistance of less than 50 Ω/m (Ohms per meter).

According to a further embodiment of the invention, the signal cable STP is further configured to transmit an (LVDS) voltage signal-for example, ANSI/TIA/EIA-644-1995 compliant and/or having symmetrical and/or differential voltage levels. The signal transmission system can, for example, be operated (bidirectionally) in a half-duplex (HDX) such that the two transmitting/receiving circuits (PHY, PHY′) are allowed to operate alternately in a transmitting and receiving mode in order to establish first and second transmission channels with opposite transmission directions.

The transmitting/receiving circuit PHY according to the invention, which is supplied, for example, by means of a (unipolar) direct voltage Un, in particular lying in a voltage range between 1.5 V (volts) and 3.5 V, comprises a receiving circuit PHY-R with an (LVDS) signal input (rx1, rx2), in particular having an input resistance of more than 1 M Ω (megaohm), for an, in particular ANSI/TIA/EIA-644-1995 (LVDS) compliant, differential (LVDS) voltage signal and with a data output Dout (forming a data output of the transmitting/receiving circuit) for an, in particular ANSI/TIA/EIA-485 (UART) compliant and/or binary, data signal, as well as a transmitter circuit PHY-T with an, in particular controllable, electronic (direct) current source with a (positive) first electrical (current source) pole (+) and with a (negative) second electrical (current source) pole (−), with a data input Din (forming a data input of the transmitting/receiving circuit) for an, in particular ANSI/TIA/EIA-485 (UART) compliant and/or binary, (UART) data signal and with an (LVDS) signal output (tx1, tx2) having a first connection pin tx1 and a second connection pin tx2 for an, in particular ANSI/TIA/EIA-644-1995 (LVDS) compliant, differential (LVDS) voltage signal.

According to a further embodiment of the invention, the (LVDS) signal input (rx1, rx2) of the receiver circuit PHY-R also has a first connection pole rx1 and a second connection pole rx2. The transmitter circuit PHY-T and/or the receiver circuit PHY-R can advantageously each also be designed as an integrated circuit, e.g., as a component of an application-specific integrated circuit (ASIC)—for example, also such that the transmitter circuit PHY-T and the receiver circuit PHY-R are components of one and the same (application-specific) integrated circuit.

In addition to the transmitter and receiver circuits (PHY-T, PHY-R), the transmitting/receiving circuit PHY according to the invention further comprises a first (two-pole) resistance element R1, e.g., having an ohmic resistance (value) of more than 10 Ω (Ohm), a second (two-pole) resistance element R2, e.g., having an ohmic resistance (value) of not less than 10 Ω and/or identical to the first resistance element R1, and (for connecting a signal cable having a pair of signal conductors) a (cable) connection device with a first connection pole tr1 and with a second connection pole tr2. The connection device can be formed, for example, by means of a plug, pin, or spring strip (arranged on a printed circuit board of the transmitting/receiving circuit), by means of soldering pins and/or by means of (PCB) terminals. As shown in FIGS. 1 and 2, the connection pole tx1 of the transmitter circuit PHY-T is electrically connected, e.g., permanently, to the first connection pole tr1 of the connection device with the first resistance element connected therebetween, and the connection pole tx2 of the transmitter circuit PHY-T is electrically connected, e.g., permanently, to the connection pole tr2 of the connection device with the second resistance element connected therebetween. To limit a (maximum) fault current (of the receiver circuit), in particular to a (short-circuit) current value compliant with IEC 60079-11:2011, the transmitting/receiving circuit PHY according to a further embodiment of the invention further comprises a third (two-pole) resistance element R3, e.g., having an ohmic resistance of more than 100 Ω, and a fourth (two-pole) resistance element R4, e.g., having an ohmic resistance of more than 100 Ω and/or identical to the third resistance element, wherein the third resistance element electrically connects the first connection pole rx1 of the receiver circuit PHY-R to the first connection pole tr1 of the connection device, and the fourth resistance element electrically connects the second connection pole rx2 of the receiver circuit PHY-R to the second connection pole tr2 of the connection device, in particular permanently.

The transmitter circuit PHY-T of the transmitting/receiving circuit PHY according to the invention further comprises at least two operating modes (T-I, T-II), each of which can be selected or activated, for example, by means of at least one value-discrete selection signal at a (first) control input of the transmitter circuit PHY-T. In particular, the transmitter circuit PHY-T is configured, in a first operating mode T-I (transmitting mode), to convert an, in particular ANSI/TIA/EIA-485 (UART) compliant and/or binary, (UART) data signal din, e.g., a 1-bit data signal, at the data input Din into an, in particular ANSI/TIA/EIA-644-1995 (LVDS) compliant and/or symmetrical, differential (LVDS) voltage signal at the (LVDS) signal output, viz., as also schematically shown in FIG. 1, depending upon a signal state of the data signal (at the data input), to electrically connect or keep interconnected the first (current source) pole (+) to one of the first and second connection poles of the (LVDS) signal output (tx1, tx2) and, complementarily thereto, the second (current source) pole (−) to the other of the first and second connection poles of the (LVDS) signal output (tx1, tx2), or to swap electrical connections established between the first and second (current source) poles and a different one of the first and second connection poles of the (LVDS) signal output (tx1, tx2) as a function of a signal edge of the data signal (at the data input) (mediating between two signal states of the data signal). In the aforementioned case that the transmitting/receiving circuit PHY is electrically connected to another transmitting/receiving circuit (PHY′) via a signal cable (STP), a (loop) current iLVDS with a predeterminable, in particular at least temporarily kept constant, current intensity can be driven or impressed in the current loop-here involving at least the current source, the two signal conductors of the signal cable STP, and the transmitting/receiving circuit PHY′; this in particular in such a way that the aforementioned (loop) current iLVDS in the case of a data signal din having a first signal state (HIGH→1) has a first current direction (+), and that the (loop) current iLVDS in the case of a (UART) data signal having a second signal state (LOW→0) different from the first signal state (HIGH) has a second current direction (−) opposite to the first current direction (+), whereby the (UART) data signal din is modulated to the (loop) current iLVDS, or the transmitter circuit PHY-T serves as an LVDS driver which converts the data signal din supplied via the signal input Din into a voltage signal having a differential voltage level or that is ANSI/TIA/EIA-644-1995 compliant. In order to limit the aforementioned (loop) current iLVDS or a (maximum) fault current (of the transmitter circuit), in particular to a (short-circuit) current value compliant with IEC 60079-11:2011, according to a further embodiment of the invention, the transmitter circuit PHY-T is further configured in the first operating mode to electrically connect the current source and the first and second resistance elements (R1, R2) in series or to keep them electrically connected in series, and/or it is provided that, when the transmitter circuit PHY-T is operating in the first operating mode, each of the first and second resistance elements form a series resistance of the transmitter circuit PHY-T between the current source and the respective connection pole of the (LVDS) signal output (tx1, tx2), in particular a series resistance limiting a (nominal) short-circuit current.

The transmitter circuit PHY-T of the transmitting/receiving circuit PHY according to the invention is, as also schematically shown in FIG. 2, further configured in a second operating mode T-II (terminating operation) to electrically short-circuit or keep short-circuited the first and second terminals of the (LVDS) signal output (tx1, tx2); in particular in such a way that the first and second resistance elements are electrically connected in series (for the purpose of forming a current divider involving the (LVDS) signal input). In the aforementioned case that the transmitting/receiving circuit PHY is electrically connected to another transmitting/receiving circuit (PHY′) via a signal cable (STP), a terminating resistor (of the signal cable) is formed which electrically connects the signal conductors at the (respective) line end on the PHY-R side of the receiver circuit. The terminating resistor formed by the first and second resistance elements serves here in particular to establish a voltage drop serving as an (LVDS) voltage signal (with a voltage level proportional to a current flowing therein and a polarity dependent upon its current direction) at the input of the receiver circuit PHY-R. The voltage drop can then be generated, for example, by means of a (loop) current iLVDS driven by the aforementioned transmitting/receiving circuit PHY′ or its transmitter circuit, possibly also modulated in the same way as the aforementioned (by means of the transmitter circuit PHY-T). Advantageously, the resistances of the first and second resistance elements can also be selected such that their (resistance) sum matches the wave impedance of the aforementioned signal cable (STP) (to be connected to the transmitting/receiving circuit or the first and second connection poles of the connection device), or that the series-connected first and second resistance elements (R1, R2) form a correspondingly optimized terminating resistance of the signal cable. According to a further embodiment of the invention, the (LVDS) signal input (rx1, rx2) of the receiver circuit PHY-R has a high input resistance of more than 1 M Ω (megaohm), not least in order to allow as low a (partial) current as possible to flow through said signal input during operation compared to a (partial) current flowing through the aforementioned terminating resistor. According to a further embodiment of the invention, the transmitter circuit PHY-T is also configured, in the second operating mode, to electrically separate or keep electrically separated the current source from at least one, in particular each, of the first and second connection poles of the (LVDS) signal output (tx1, tx2) and/or to electrically separate or keep electrically separated the (LVDS) signal output from at least one of the first and second (current source) poles (+, −).

According to a further embodiment of the invention, the receiver circuit PHY-R also has at least two operating modes (R-I, R-II), each of which can be selected or activated, for example, by means of a value-discrete selection signal at a control input of the receiver circuit PHY-R. The receiver circuit PHY-R is particularly configured, in a first operating mode R-I (receiving mode), to process a differential (LVDS) voltage signal, specifically having an, in particular ANSI/TIA/EIA-644-1995 (LVDS) compliant and/or symmetrical, differential voltage level (uLVDS) at the (LVDS) signal input (rx1, rx2), viz., to receive it and to convert it into an, in particular ANSI/TIA/EIA-485 (UART) compliant and/or binary, (UART) data signal, in particular a 1-bit data signal, at the data output Dout, or to operate as an LVDS receiver. For this purpose, the receiver circuit PHY-R is further configured according to a further embodiment of the invention to convert (in its first operating mode R-I) an input voltage uLVDS applied to the (LVDS) signal input (rx1, rx2) into a corresponding output voltage at the signal output Dout, which serves as a data signal dout of the receiver circuit; this is done in particular in such a way that the output voltage (only) at a (positive) input voltage uLVDS (uLVDS→+uLVDS) with a voltage level exceeding a (positive) first switching voltage threshold value (different from zero), e.g., not less than +5 mV (millivolts), assumes a (positive) first voltage level, in particular different from zero and/or not less than +500 mV, or has (continues to have) the first voltage level at a voltage level above the same switching voltage threshold value. Advantageously, the receiver circuit PHY-R can further be configured in such a manner that its aforementioned switching voltage threshold value is not less than +5 mV—for example, also greater than +7 mV and/or less than +200 mV. The receiver circuit PHY-R is additionally configured (in its first operating mode R-I) to convert the input voltage uLVDS into the aforementioned output voltage (dout) in such a manner that the output voltage (only) at a (negative) input voltage uLVDS (uLVDS→−uLVDS) with a voltage level falling below a second switching voltage threshold value (different from the aforementioned first switching voltage threshold value as well as from zero) assumes a second voltage level deviating from the first voltage level of the output voltage, e.g., zero or also different from zero (negative), or has a second voltage level if the voltage level is below the second switching voltage threshold value. The aforementioned second switching voltage threshold value may accordingly be below the aforementioned first switching voltage threshold value. Advantageously, the receiver circuit PHY-R can further be configured in such a manner that its second switching voltage threshold value is not more than −5 mV—for example, less than −7 mV and/or greater than −200 mV. In addition, the receiver circuit PHY-R can be further configured in such a manner that the first and second switching voltage threshold values (representing different polarities of the input voltage uLVDS) have different signs from one another, for example, in such a manner that the first switching voltage threshold value has a positive sign (+) and the second switching voltage threshold value has a negative sign (−); thus, the first switching voltage threshold value is accordingly above zero, and the second switching voltage threshold value is accordingly below zero, in particular also in such a manner that the first and second switching voltage threshold values are of an equal amount.

According to a further embodiment of the invention, the receiver circuit PHY-R is further configured, in a second operating mode, not to convert a differential (LVDS) voltage signal, e.g., an ANSI/TIA/EIA-644-1995 (LVDS) compliant voltage signal, at the (LVDS) signal input (rx1, rx2) into a data signal at the data output Dout, or, in the second operating mode, not to output a data signal at the data output Dout.

For selecting the aforementioned first and second operating modes (T-I, T-II), the transmitter circuit PHY-T may have a (first) control input DE for a value-discrete, e.g., binary, (operating mode) selection signal. In addition, the receiver circuit PHY-R can also have a control input RE for a discrete-value, e.g., binary, (operating mode) selection signal, which is useful for selecting its previously designated first and second operating modes (R-I, R-II).

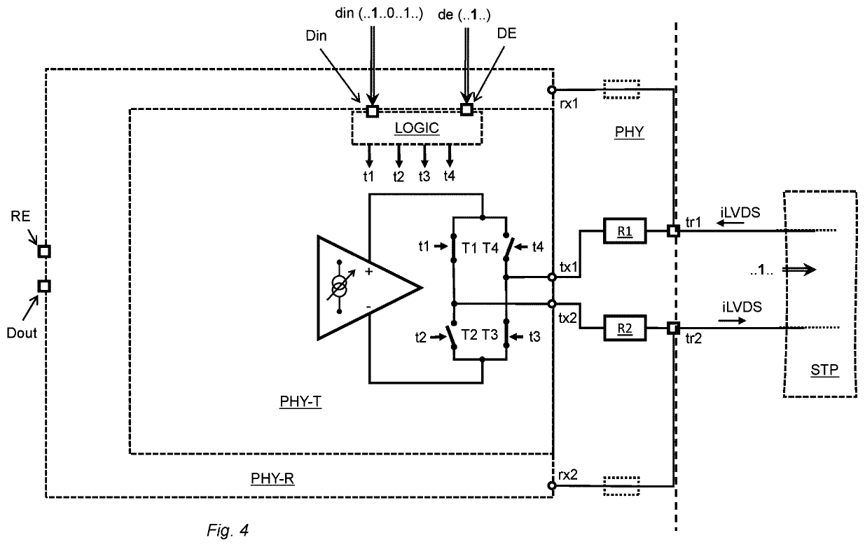

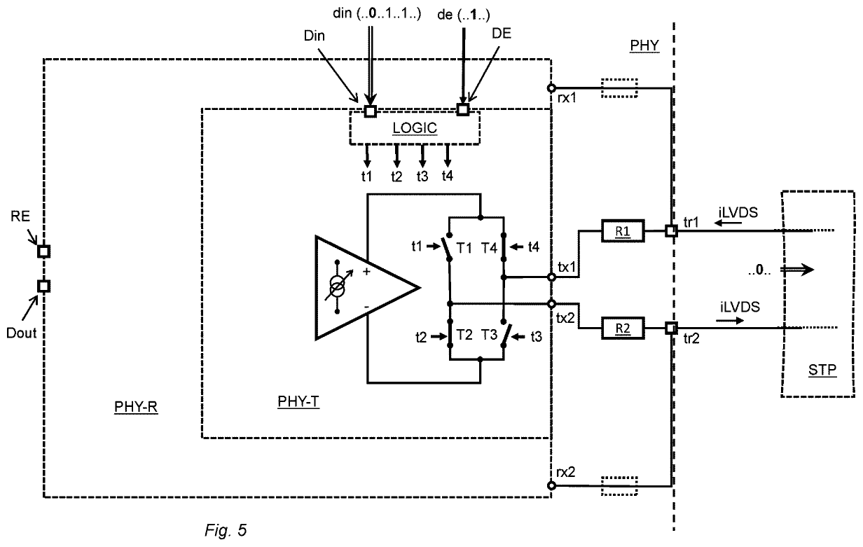

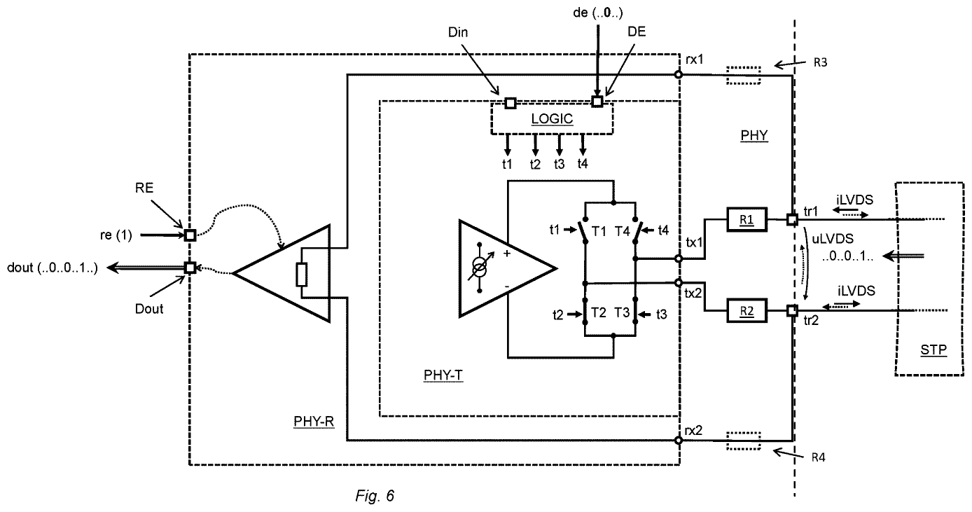

For connecting the first and second resistance elements R1, R2 in the manner described above, the transmitter circuit PHY-T comprises, according to a further embodiment of the invention shown schematically in FIGS. 4, 5, and 6, an (H-)bridge circuit formed by means of a first (semiconductor) switch T1, a second (semiconductor) switch T2, a third (semiconductor) switch T3, and a fourth (semiconductor) switch T4. According to a further embodiment of the invention, each of the first, second, third, and fourth (semiconductor) switches has at least one control terminal. As schematically illustrated in FIGS. 4, 5, or 6, a supply input of the bridge circuit is electrically connected to the current source, and a bridge arm of the bridge circuit is electrically connected to the first and second connection poles of the (LVDS) signal output (tx1, tx2); this in particular such that a series circuit of the first and second switches and a series circuit of the third and fourth switches are electrically connected in parallel, or that the first and fourth switches are electrically connected to the first (current source) pole (+), and the second and third switches are electrically connected to the second (current source) pole (−). In particular, the transmitter circuit (PHY-T) is further configured, in the first operating mode, in the case of a data signal at the data input Din with a first signal state (HIGH), e.g., corresponding to a logic one ( . . . 1 . . . ) , as also schematically shown in FIG. 4, both to close the (mutually diagonal) first and third switches T1, T3 or to keep them closed and to open the (mutually diagonal) second and fourth switches T2, T4 and, as also schematically shown in FIG. 5, in the case of a data signal at the data input Din with a second signal state (LOW), e.g., corresponding to logic zero, that differs from the first signal state (HIGH), both to open the first and third switches T1, T3 or to keep them open and to close or keep the second and fourth switches (of the bridge circuit) closed. Furthermore, the transmitter circuit PHY-T is configured, in the first operating mode, in the case of a data signal at the data input Din with a signal edge transitioning from the aforementioned first signal state (HIGH) to the second signal state (LOW), both to open the first and third switches T1, T3 or to keep them open and to close or keep closed the second and fourth switches T2, T4 accordingly, or in the case of a data signal at the data input Din with a signal edge transitioning from the second signal state (LOW) to the first signal state (HIGH), both to close the first and third switches T1, T3 or to keep them closed and to open or keep the second and fourth switches T2, T4 open. To control the bridge circuit, the transmitter circuit PHY-T according to a further embodiment of the invention further comprises a (hardware) control logic (LOGIC) with the first, second, third, and fourth control outputs serving to control the first, second, third, and fourth (semiconductor) switches. The control logic is also particularly designed, in the first operating mode of the transmitter circuit PHY-T when a data signal having the aforementioned first signal state is present at the data input Din, to close or keep closed the first and third switches and to open or keep open the second and fourth switches. Furthermore, the control logic is also designed to open or keep open the first and third switches and to close or keep closed the second and fourth switches when a data signal having the aforementioned second signal state is present at the data input Din. For this purpose, according to a further embodiment, each of the first, second, third, and fourth control outputs (of the control logic) is electrically connected to (exactly) one associated control terminal of the first, second, third, and fourth (semiconductor) switches, and vice versa. Alternatively or additionally, the control logic further comprises a first control input and a second control input, wherein the first control input forms the aforementioned (first) control input DE of the transmitting/receiving circuit PHY, and the second control input forms the data input Din of the transmitting circuit PHY-T or is electrically coupled thereto.

1-19. (canceled)

20. A transmitting/receiving circuit for signal transmission, the transmitting/receiving circuit comprising:
a receiver circuit with a signal input for a differential voltage signal and with a data output for a data signal;
a transmitter circuit with an electronic current source with a first electrical pole and with a second electrical pole, with a data input for a data signal, and with a signal output having a first connection pole and a second connection pole for a differential voltage signal;
a first resistance element;
a second resistance element; and
a connecting device with a first connection pole and with a second connection pole,
wherein the first connection pole of the transmitter circuit is electrically connected to the first connection pole of the connection device with the first resistance element connected therebetween, and the second connection pole of the transmitter circuit is electrically connected to the second connection pole of the connection device with the second resistance element connected therebetween, and
wherein the transmitter circuit has at least two operating modes, such that the transmitter circuit is configured in a first operating mode to convert a data signal at the data input into a differential voltage signal at the signal output, depending upon a signal state of the data signal, to electrically connect or keep interconnected the first pole to one of the first and second connection poles of the signal output and, complementarily thereto, the second pole to the other of the first and second connection poles or, depending upon a signal edge of the data signal, to swap electrical connections established between the first and second poles and a different one of the first and second connection poles of the signal output, and that the transmitter circuit is configured in a second operating mode to electrically short-circuit or keep short-circuited the first and second connection poles of the signal output.

21. The transmitting/receiving circuit according to claim 20,
wherein the transmitter circuit is configured in the first operating mode to electrically connect the current source and the first and second resistance elements in series or to keep them electrically connected in series; and/or
wherein, when the transmitter circuit is operating in the first operating mode, each of the first and second resistance elements forms a series resistance of the transmitter circuit between the current source and the respective connection pole of the signal output.

22. The transmitting/receiving circuit according to claim 21,
wherein the transmitter circuit is configured in the second operating mode to electrically isolate or keep electrically isolated the current source from at least one of the first and second terminal poles of the signal output; and/or
wherein the transmitter circuit is configured in the second operating mode to electrically separate or keep electrically separated the signal output from at least one of the first and second poles.

23. The transmitting/receiving circuit according to claim 22, wherein the transmitter circuit is configured in the second operating mode to electrically connect the first and second resistance elements in series or to keep them electrically connected in series.

24. The transmitting/receiving circuit according to claim 20,
wherein the receiver circuit has at least two operating modes such that the receiver circuit is configured in a first operating mode to convert an ANSI/TIA/EIA-644-1995 compliant, differential voltage signal at the signal input into a data signal at the data output, and that the receiver circuit is configured, in a second operating mode, not to convert a differential voltage signal at the signal input into a data signal at the data output or not to output a data signal at the data output.

25. The transmitting/receiving circuit according to claim 20, wherein the signal input of the receiver circuit has a first connection pole and a second connection pole.

26. The transmitting/receiving circuit according to claim 25, further comprising:
a third resistance element; and
a fourth resistance element.

27. The transmitting/receiving circuit according to claim 26, wherein the third resistance element electrically connects the first connection pole of the receiver circuit to the first connection pole of the connection device, and the fourth resistance element electrically connects the second connection pole of the receiver circuit to the second connection pole of the connection device.

28. The transmitting/receiving circuit according to claim 20,
wherein the transmitter circuit is designed as an integrated circuit; and/or
wherein the receiver circuit is designed as an integrated circuit; and/or
wherein the transmitter circuit and the receiver circuit are part of one and the same integrated circuit.

29. The transmitting/receiving circuit according to claim 20, wherein the transmitter circuit has a bridge circuit formed by first, second, third, and fourth switches, of which bridge circuit a supply input is electrically connected to the current source and of which bridge circuit a bridge branch is electrically connected to the first and second connection poles.

30. The transmitting/receiving circuit according to claim 29,
wherein the transmitter circuit is configured, in the first operating mode, to close or keep closed the first and third switches and to open or keep open the second and fourth switches in the case of a data signal at the data input with a first signal state corresponding to logic one; and
wherein the transmitter circuit is configured, in the first operating mode, to open or keep open the first and third switches and to close or keep closed the second and fourth switches in the case of a data signal at the data input with a second signal state corresponding to logic zero, that differs from the first signal state.

31. The transmitting/receiving circuit according to claim 30,
wherein the transmitter circuit is configured, in the first operating mode, to open and keep open the first and third switches and to close and keep closed the second and fourth switches in the case of a data signal at the data input with a signal edge transitioning from the first signal state to the second signal state; and
wherein the transmitter circuit is configured, in the first operating mode, to close or keep closed the first and third switches and to open or keep open the second and fourth switches in the case of a data signal at the data input with a signal edge transitioning from the second signal state to the first signal state.

32. The transmitting/receiving circuit according to claim 31, wherein the transmitter circuit comprises a control logic with first, second, third, and fourth control outputs for controlling the first, second, third, and fourth switches of the bridge circuit, respectively.

33. The transmitting/receiving circuit according to claim 32,
wherein the control logic is configured, in the first operating mode of the transmitter circuit, to close or keep closed the first and third switches and to open or keep open the second and fourth switches in the case of a data signal at the data input with a first signal state corresponding to logic one; and
wherein the control logic is configured, in the first operating mode of the transmitter circuit, to open or keep open the first and third switches and to close or keep closed the second and fourth switches in the case of a data signal at the data input with a second signal state, in particular corresponding to logic zero, that differs from the first signal state.

34. The transmitting/receiving circuit according to claim 33, wherein each of the first, second, third, and fourth switches has a control terminal, and each of the first, second, third, and fourth control outputs is electrically connected to one associated control terminal of the first, second, third, and fourth switches, and vice versa; and/or wherein the control logic has a first control input and a second control input.

35. The transmitting/receiving circuit according to claim 34, wherein the first and second operating modes of the transmitter circuit can each be selected or activated via at least one value-discrete selection signal at the control input of the transmitter circuit.

36. A signal transmission system, comprising:
a transmitting/receiving circuit for signal transmission, the transmitting/receiving circuit including:
a receiver circuit with a signal input for a differential voltage signal and with a data output for a data signal;
a transmitter circuit with an electronic current source with a first electrical pole and with a second electrical pole, with a data input for a data signal, and with a signal output having a first connection pole and a second connection pole for a differential voltage signal;
a first resistance element;
a second resistance element; and
a connecting device with a first connection pole and with a second connection pole,
wherein the first connection pole of the transmitter circuit is electrically connected to the first connection pole of the connection device with the first resistance element connected therebetween, and the second connection pole of the transmitter circuit is electrically connected to the second connection pole of the connection device with the second resistance element connected therebetween, and
wherein the transmitter circuit has at least two operating modes, such that the transmitter circuit is configured in a first operating mode to convert a data signal at the data input into a differential voltage signal at the signal output, depending upon a signal state of the data signal, to electrically connect or keep interconnected the first pole to one of the first and second connection poles of the signal output and, complementarily thereto, the second pole to the other of the first and second connection poles or, depending upon a signal edge of the data signal, to swap electrical connections established between the first and second poles and a different one of the first and second connection poles of the signal output, and that the transmitter circuit is configured in a second operating mode to electrically short-circuit or keep short-circuited the first and second connection poles of the signal output.

37. The signal transmission system according to claim 36, further comprising:
a further transmitting/receiving circuit; and
a signal cable having at least one pair of signal conductors.

38. The signal transmission system according to claim 37,
wherein the two transmitting/receiving circuits are electrically connected via the signal cable to form a current loop; and/or
wherein the signal cable has a length of more than 20 meters; and/or
wherein the signal cable has a wave impedance of not less than 20 Ω.
